(19) United States
(12) Patent Application Publication
(10) Pub. No.: US 2007/0271358 A1
(43) Pub. Date: Nov. 22, 2007

(54) System and Method for Dynamically Configured, Asymmetric Endpoint Video Exchange

(76) Inventor: William Gaddy, Milford, PA (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 10/589,064

(22) PCT Filed: Jan. 14, 2005
(86) PCT No.: PCT/US05/01412

§ 371 Date: Apr. 23, 2007

Related U.S. Application Data
(60) Provisional application No. 60/537,472, filed on Jan. 16, 2004.

(51) Int. Cl. G06F 15/177

(52) U.S. Cl. 709/222

(57) ABSTRACT

Provided herein are exemplary embodiments of a system for and method of initially and dynamically allocating the available resources that affect video quality in an asymmetric endpoint network so as to provide an enhanced quality of video exchange. Relevant variables that may be dynamically configured to allocate resources include, but are not limited to, frame size, frame rate, choice of codec (e.g., MPEG4, H263, H263+, H264), codec bit rate and size of rendering window (which may or not be identical to the frame size).

### CROSS-REFERENCE TO RELATED APPLICATIONS

This application claims the benefit of priority to U.S. Application No. 60/537,472 filed on Jan. 16, 2004, the entire disclosure of which is hereby incorporated by reference as if set forth at length herein.

### STATEMENT REGARDING FEDERALLY SPONSORED RESEARCH OR DEVELOPMENT

Not applicable

### REFERENCE OF A “MICROFICHE APPENDIX”

Not applicable

### BACKGROUND OF THE INVENTION

1. Field of Invention

The present invention relates, in general, to video communications systems and methods, and more particularly to a system and method for dynamically configuring endpoints in an asymmetric full duplex video communications system.

2. Brief Description of the Prior Art

Advanced consumer and commercial interactive video services, such as video conferencing and video chat, require hardware, software and transmission systems with high quality, full duplex video capability. In order to achieve the required level of video experience, most professional videoconferencing solutions use endpoints (terminals) of the system with identical hardware capabilities and architectures, and make use of private, dedicated high-speed data links. The use of such custom hardware software and transmission systems are expensive. Moreover, most businesses, and many individuals, have existing computer systems and high-speed network access that they would like to utilize for their video conferencing, video chat and other related video applications. The problem is, in the business and personal computing environments, that different users typically have different systems with different capabilities. In addition, they are usually connected by a public network which has varying and unpredictable bandwidth. These factors present major challenges in providing a sufficiently robust video experience for videoconferencing, video chat and related video applications.

For instance, in the current business and personal computing environment, there is a vast range of computer Central Processing Unit (CPU) capabilities used in the endpoints discussed above. For example the clock speeds presently vary from 300 MHz through 3 GHz. There is also a vast array of hardware-assisted methods, provided on “graphics cards”, for improving real-time video rendering for both 2D and 3D. These all directly affect the quality and “quantity” of video (e.g. frame size and frame rate) that a given endpoint can capture, encode and send and/or receive, decode and render

A very typical problem in desktop video environments is what happens when a low-end machine with a 300 MHz CPU wants to communicate with a high-end machine, with a 3 GHz CPU. If the high-end machine captures and encodes at its limit of capabilities, it will supply video at a rate that will overwhelm the capabilities of the 300 Mhz machine. For instance, the 300 Mhz machine may spend all of its time decoding the other party's video and therefore not have any CPU capacity left over to capture/encode video for the other party.

In addition to the capabilities of the endpoints usually being asymmetric, the CPU requirements of the encoding and decoding functions are themselves asymmetric. Typically encoding consumes anywhere from two to four times the CPU required for decoding if all dependent variables, such as video size, frame rate, and bit rate, are held constant.

These difficulties are further compounded when video conferencing, or any other application requiring advanced interactive video, is implemented using publicly available or shared networks, such as the Internet. Typically Internet network connections have very limited upload capabilities and their uplink speeds are often capped. On networks where multiple users contend for the same space on the “upload pipe”, such as Digital Subscriber Lines (DSL) and cable modems, actual maximum throughput can vary widely and unpredictably

For videoconferencing applications, and many other advanced interactive video applications, it would be ideal to use a video codec (coder and decoder) that produced exactly the number of bits that the user required. In reality, even codecs designed for videoconferencing applications have some jitter and produce unexpected peaks and troughs in actual output bitrate. A common approach to solving this problem is to apply a “leaky bucket” to the output of the codec, thereby allowing the input to the bucket to vary while the “hole in the bottom” releases output in a constant flow. While smoothing the output bitrate, this solution has the problematic effect of increasing system latency. This extra latency occurs because when the codec output bitrate temporarily peaks, and large amount of bits are temporarily poured into the bucket, it will take longer for those bits to finally drop out of the bottom, i.e. the water stays longer in the bucket.

In addition, this type of scheme complicates synchronization of multiple streams, such as audio and video, because they have differing bitrates and typically have different peak and trough characteristics (audio is usually more constant than video). Effectively the longest latency of either stream becomes the system latency because the streams must be synchronized at the receiver.

### SUMMARY OF THE INVENTION

The present invention addresses the aforementioned limitations of the prior art by providing, in accordance with one aspect of the present invention, a system and method for initially and dynamically allocating the available resources that affect video quality in an asymmetric endpoint network so as to provide an enhanced quality of video exchange. Relevant variables that may be dynamically configured to allocate resources include, but are not limited to, frame size, frame rate, choice of codee (e.g., MPEG4, H263, H263+, H264), codec bit rate and size of rendering window (which may or not be identical to the frame size).

In accordance with a second aspect, the invention includes a method of initializing a video system, said video system including at least a first and a second endpoint connected via a communications network; said method including: determining first endpoint parameters of said first endpoint; sending said first endpoint parameters along with an invite request to said second endpoint; receiving said the invite request and first endpoint parameters at said second endpoint; determining second endpoint parameters of said second endpoint; sending an acknowledgement along with said second parameters to said first endpoint; and referring to common tables at said first and second endpoints to initializes said first and second endpoints with each endpoint using the parameters of the other endpoint to select appropriate parameter values.

During the session, the system continues to monitor performance to dynamically adjust the allocation of resources for all currently participating endpoints

These and other aspects, features and advantages of the present invention will become better understood with regard to the following description, appended claims, and accompanying drawings.

### BRIEF DESCRIPTION OF THE DRAWINGS

Exemplary embodiments of the present invention will now be briefly described with reference to the following drawings:

FIG. 1 depicts one aspect of the prior art in accordance with the teachings presented herein.

FIG. 2 depicts a second aspect of the prior art in accordance with the teachings presented herein.

FIG. 3 depicts an aspect of the present invention in accordance with the teachings presented herein.

FIG. 4 depicts an aspect of the present invention in accordance with the teachings presented herein.

FIG. 5 depicts an aspect of the present invention in accordance with the teachings presented herein.

### DESCRIPTION OF THE INVENTION

The aspects, features and advantages of the present invention will become better understood with regard to the following description with reference to the accompanying drawings. What follows are preferred embodiments of the present invention. It should be apparent to those skilled in the art that the foregoing is illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto. During the course of this description like numbers will be used to identify like elements according to the different views that illustrate the invention.

### OVERVIEW

As described below in detail, the inventive concepts of the present invention provide a high quality video and audio service for advanced interactive and full duplex video services such as, but not limited to, video conferencing.

A preferred embodiment of the present invention is able to initially and dynamically allocate central processing unit (CPU) usage and network bandwidth to optimize perceived video quality as required in order to deal with asymmetric endpoint equipment and systems as well as the inherent asymmetries of encoding and decoding video streams. The variables that may be initially and dynamically configured in order to allocate the CPU usage and network bandwidth include, but are not limited to, frame size, frame rate, choice of codec (e.g. MPEG4, H263, H263+, H264), codec bit rate, size of rendering window (which may or not be identical to the frame size). For instance, in a simple example, since encoding and decoding are asymmetric, the 300 Mhz/3 Ghz endpoint pair mentioned previously could be optimally configured by having the 300 Mhz machine encode at 160×120 pixels, 15 frames per second, which would leave enough CPU to let it decode 176×144, at 24 frames per second. In the preferred embodiment, the two or more endpoints each arrive at their solutions cooperatively in order to ensure the best possible video playback experience on all machines.

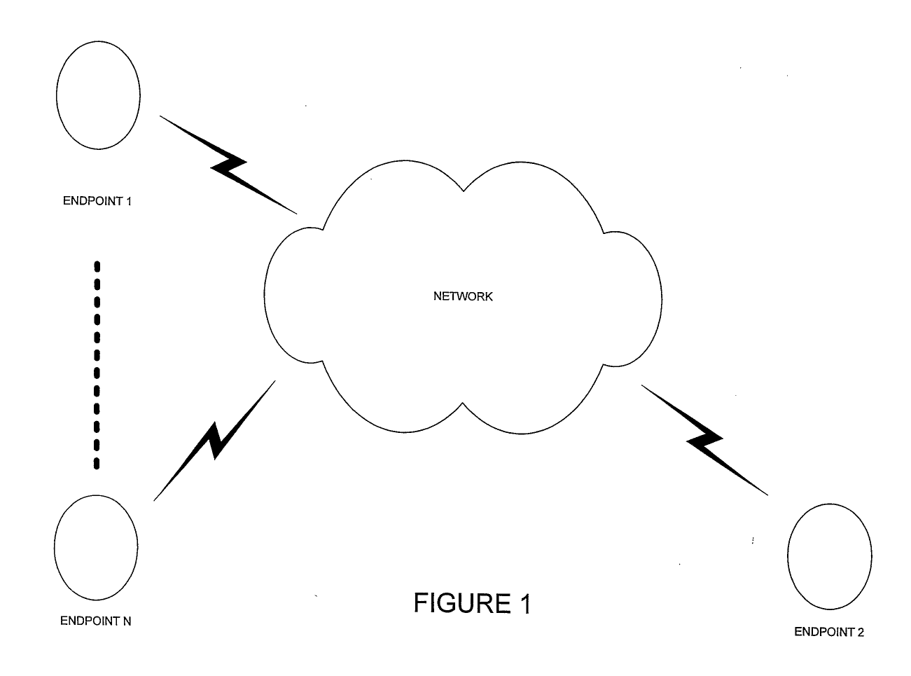

FIG. 1—System Architecture

FIG. 1 is a high-level block diagram of an exemplary system for providing high quality video and audio over a communications network according to the principles of this invention. Generally, the system includes any number of endpoints that interface with a communications network.

The communications network can take a variety of forms, including but not limited to, a local area network, the Internet or other wide area network, a satellite or wireless communications network, a commercial value added network (VAN), ordinary telephone lines, or private leased lines. The communications network used need only provide fast reliable data communication between endpoints.

Each of the endpoints can be any form of system having a central processing unit and requisite video and /or audio capabilities, including but not limited to, a computer system, main-frame system, super-mini system, mini-computer system, work station, laptop system, handheld device, mobile system or other portable device, etc.

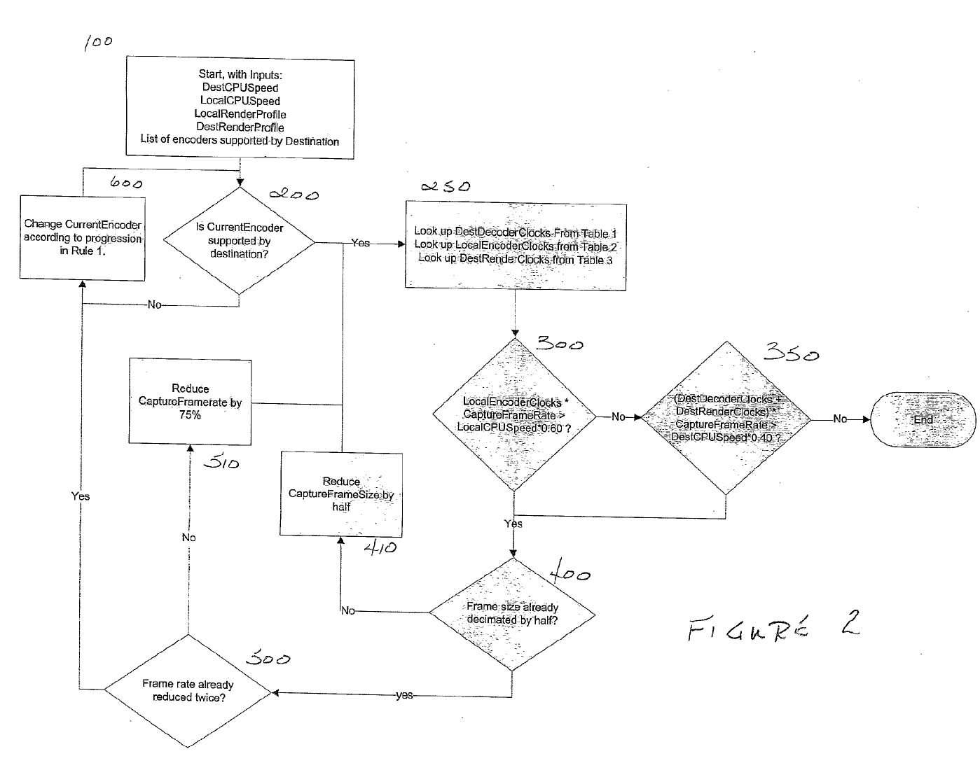

FIG. 2—Method of Operation

FIG. 2 is a high-level process flow diagram of an exemplary method of operation carried out by the system according to the inventive concepts of this invention.

Initially, the first endpoint performs a self-diagnostic check to determine several parameters, such as the effective CPU speed of the first endpoint, hardware rendering capabilities of the first endpoint, hardware color conversion capabilities of the first endpoint, CPU step-down profile of the first endpoint, etc. The first endpoint then transmits its parameters along with an invite request message to the second endpoint. The second endpoint receives the invite request, and if the request is acknowledged, performs a self-diagnostic check to determine several parameters, such as the effective CPU speed of the second endpoint, the hardware rendering capabilities of the second endpoint, the hardware color conversion capabilities of the second endpoint and the CPU step-down profile of the second endpoint. Next, the second endpoint transmits its parameters along with an acknowledgement message to the first endpoint.

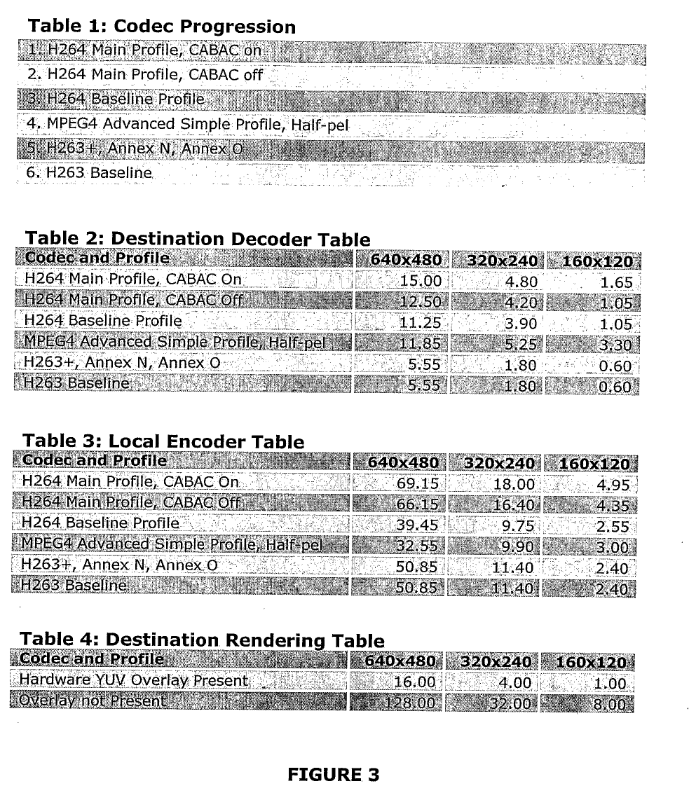

Having acquired respective parameters, each endpoint derives optimized heuristic parameter settings for the different combinations of endpoint capabilities by referring to common tables, see FIG. 3, below, and performing the process flow shown in FIG. 2.

Referring specifically to FIGS. 2 and 3, at 100, a given endpoint starts with the following knowledge about the performance characteristics of the local and destination endpoints: the CPU speed of the destination endpoint, e.g., in MHz; the CPU speed of the local endpoint, in e.g., MHz; an ordinal profile number used to look up approximation of CPU cost, in e.g., MHz, of rendering on the destination endpoint; an ordinal profile number used to look up. an approximation of CPU cost, in e.g., MHz of rendering on the local endpoint; a list of encoding formats that the destination endpoint can decode; a current frame size, set to a default (such as, e.g., 320×240); a current frame rate, set to a default (such as, e.g., 30); and a current encoder format, set by default to the first encoding format in Table 1 of FIG. 3.

At 200, the system determines if the destination endpoint can decode the current encoder format. If yes, processing continues to step 250. If no, processing continues to step 600.

At 250, the system performs the following three finctions:
Using the current frame size, a first cost factor (COST 1) is obtained by table lookup in Table 2 (see FIG. 3). Cost 1 is the number of clock cycles (in MHz) to decode each frame on the destination endpoint.
Using the current frame size, a second cost factor (COST 2) is obtained by table lookup in Table 3 (see FIG. 3). Cost 2 is the number of clock cycles (in MHz) to encode each frame on the local endpoint.
Using the current frame size, a third cost factor (COST 3) is obtained by table lookup in Table 4 (see FIG. 3). Cost 3 is the number of clock cycles (in MHz) to render each frame on the destination endpoint.

At 300, the system conducts a first test to determine whether the costs for the local endpoint meet the criteria that local encoding does not consume more than 60% of the available CPU resources. To do so, the system multiplies the second cost factor (COST 2) by the current frame rate. If the resultant value does not exceed the local CPU speed multiplied by 60%, processing continues to step 350 and the system conducts a second test. Otherwise, processing continues to step 400.

At 350, the system conducts a second test to determine whether the costs for the destination endpoint meet the criteria that destination decoding and rendering does not consume more than 40% of the available CPU resources. To do so, the system adds the first and third cost factors (COST 1+COST 2), and then multiplies the result by the current frame rate. If the resultant value does not exceed the destination CPU speed multiplied by 40%, then processing terminates with the current frame size, frame rate, and encoder settings. Otherwise, processing continues to step 400.

At 400, the system determines if the current frame size is reduced once. If yes, processing continues to step 500. Otherwise, processing continues to step 410.

At 410, the system reduces the current frame size by half for each aspect, and processing returns to step 250.

At 500, the system determines if the current frame rate is twice reduced. If yes, processing continues to step 600. Otherwise, processing continues to 510.

At 510, the system reduces the current frame rate by 75% and processing returns to step 250.

At 600, the system demotes the current encoder format according to the predefined progression in Table 1 (see FIG. 3) and processing returns to step 100.

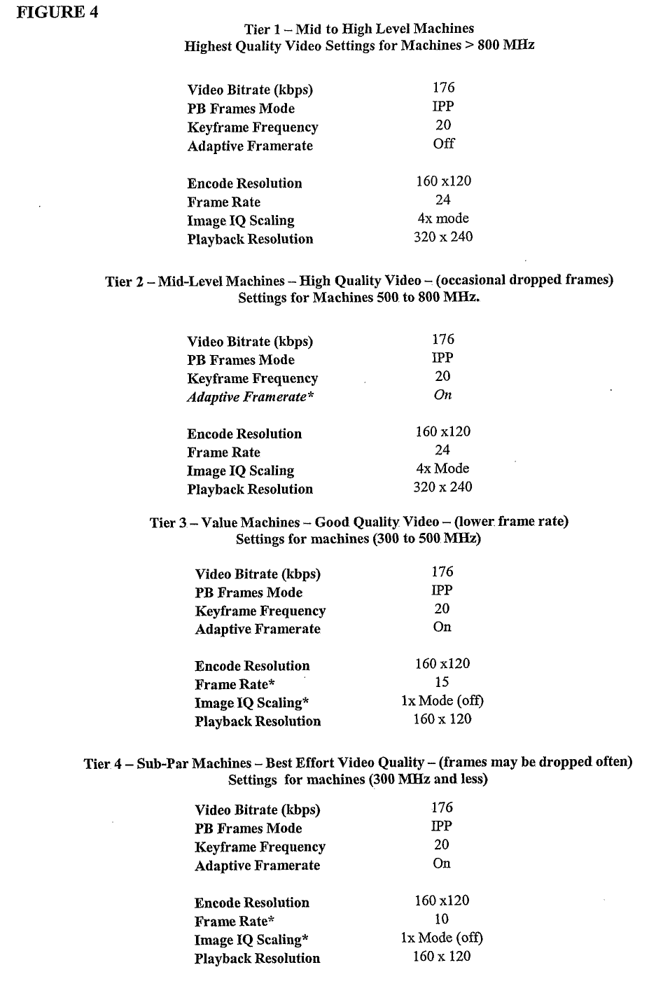

By performing the above process, each endpoint uses the capabilities of the other endpoints to derive optimized heuristic parameter settings of which frame rate, frame size, which codec, what codec bit rate, which rendering window size to use for optimal exchange of video, etc., with each of the other endpoints, see FIG. 4, below.

The following is a specific example of an implementation on a session-by-session basis to finely tune the performance characteristics of a constant bit rate full duplex video exchange in an application such as, but not limited to, a live video chat, by dynamically optimizing variables such as codec selection (chosen from, for instance, H263, MPEG4, H.26L), codec settings (chosen from, for instance, but not limited to, I-frame frequency, AP mode and full/half/quarter pel), video size and video frame rate.

During initial session negotiation, each machine exchanges their effective performance characteristics, i.e. settings. If both machines know each other's capabilities, the best settings can be adequately predicted heuristically. These settings will indicate the maximum performance available for the session. This is part of the general session negotiation where addresses and protocols are agreed upon by the two endpoints. Other issues may degrade performance after session start, as discussed below.

The following rules are applied, in order, with the least common denominator of both machines dictating the selection:

Rule 1. Codec selection. The H.26L codec will give the highest video quality, but is only appropriate for very fast machines (1.7 Ghz and above). The MPEG4 codec is appropriate for most other machines with lower CPU grades if the other settings are tuned.

Rule 2: Codec settings. The H.26L codec has several tiers that enhance video quality at the expense of CPU. Video quality can scale upwards at a constant bit rate on machines from 1.7 Ghz to 4 Ghz.

Rule 3: The MPEG4 codec can be set to drop frames intelligently (only p-frames, not I or b frames) when CPU load gets too high for intermittently slower machines. The four motion vector option can be turned off (this reduces motion search, therefore CPU, at the expense of quality of quickly moving background objects). These are meant to be selected statically at session negotiation, if the processor is of a type likely to vary its CPU capabilities (such as mobile Pentium IV).

Rule 4: If H263 is used, AP mode can be turned off and B-frames can be turned off in order to increase CPU efficiency.

Rule 5. Below 1 Ghz, the primary methods for tuning the performance are the video size and frame rate. The video will drop to QCIF or QQVGA from QVGA on machines below 1 Ghz. On machines below 800 Mhz, the framerate will be dropped to match the CPU.

In an alternative embodiment, the user has the ability to navigate to the codec settings and override these defaults, and/or to turn off video quality negotiation altogether.

FIG. 3—Common Look Up Tables

FIG. 3 illustrates the common look up tables accessed by the system endpoints according to the inventive concepts of this invention. Each system endpoint refers to these tables when deriving optimized heuristic parameter settings for different combinations of endpoint capabilities.

FIG. 4—Heuristic Parameters

As indicated previously, each endpoint derives optimized heuristic parameter settings for the different combinations of endpoint capabilities in accordance with the methods provided herein. FIG. 4 are examples of such derived heuristic parameter settings for different classes of systems measured by CPU clock speed and quality of video output. As shown, Table 1A provides exemplary parameter settings of Tier 1 systems, i.e., mid to high level systems, e.g., >800 MHz systems, that generate the highest quality video output. Table 1B provides exemplary parameter settings of Tier 2 systems, i.e., mid-level systems, e.g., 500-800 MHz systems, that generate high quality video output. Table 1C provides exemplary parameter settings of Tier 3 systems, i.e., value systems, e.g., 300-500 MHz systems, that generate good quality video output. Finally, Table 1D provides exemplary parameter settings of Tier 4 systems, i.e., sub-par systems, e.g., 300 MHz and less systems that generate best effort quality video output.

### Alternate Embodiments

While session-based negotiation of settings is a good start, the preferred embodiment of this invention includes a real-time feed back loop to continue to monitor and adjust appropriate parameters through out the video session. This is desirable because factors such as CPU load can vary widely even on a given machine. For example, Pentium IV laptops are notorious for stepping down very aggressively under load conditions (a 1.6 Ghz machine can become a 400 Mhz machine if the processor overheats). Therefore, a dynamic method of managing parameter such as CPU consumption is needed. One method of achieving this is, for instance, by dynamically altering the framerate if the CPU steps outside of the negotiated capabilities.

Another feature of this invention is to monitoer effective bandwith during the session. Both CPU load and bandwith are monitored, either peridicly or continuously, after set up and adjustments are made to accomadate changes for each of these independantly.

In real-time, a CPU deficit may be reflected in ring buffer growth. This is detected and may be used to dynamically reject/skip input video frames at the source. Overflows of the ring buffers result in an immediate shunt of input video frames. This has the effect of only pushing as much video into the encoder as it can handle, at the expense of frame rate while maintaining image-to-image quality. This approach can scale down to very slow processors (well below our low-end target) and results in small frame rates on those systems. On machines where there is no CPU deficit, video frames are never skipped or shunted and the frame rate is unaffected.

Another area that can effect real-time performance is the loss of available bandwidth on the network. Under severe network loading, packets of video and audio may be dropped by the network transmission infrastructure Based on protocols such as the Real Time Control Protocol (RTCP) streaming standard, the sender and receiver may exchange quality of service information that allow dynamically lowering the bit rate or suspending video delivery until the bandwidth starvation ends.In a further embodiment, endpoint settings are determined on a set of heuristics and associated video service tiers suitable for use on cable network environments. For instance, in a DOCSIS 256 kbps upstream network with a constant 200 kbps bandwidth allotment for video chat, 4 tier levels of video service may be determined during initial session negotiation, along the following lines:

Tier 1—Mid to High Level Machines—Highest Quality Video

Settings for Machines >800 MHz as shown in Table 1A of Appendix I.

Tier 2—Mid-Level Machines—High Quality Video—(occasional dropped frames)

Settings for Machines 500 to 800 MHz as shown in Table 1B of Appendix I.

Tier 3—Value Machines—Good Quality Video—(lower frame rate)

Settings for machines (300 to 500 MHz) as shown in Table 1C of Appendix I.

Tier 4—Sub-Par Machines—Best Effort Video Quality—(frames may be dropped often.

Settings for machines (300 MHz and less) as shown in Table 1D of Appendix I.

In addition to the endpoint hardware and software asymmetries, many Internet connections have very limited upload capabilities—their uplink speeds are typically capped, and in some cases, actual maximum throughput can vary widely on networks where multiple users contend for the same space on the “upload pipe”, such as DSL and cable modems.

For videoconferencing and related applications, it would be ideal to use a video codec that produced exactly the number of bits that you wish; in reality though, even codecs designed for this purpose have some jitter and unexpected peaks and troughs in actual output bitrate. A common approach is to apply a “leaky bucket” to the output of a codes, such that the input to the bucket can vary, and the hole in the bottom releases output in a constant flow. This has the effect of increasing system latency, for as the codec peaks, and pours a (temporarily) large amount of bits in the bucket, it will take longer for those bits to finally drop out of the bottom (the water stays longer in the bucket).

In addition, this sort of scheme complicates synchronization of multiple streams, such as audio and video, because they have differing bitrates, typically have different peak and trough characteristics (audio is usually more constant than video), and effectively the longest latency of either stream becomes the system latency because the streams must be synchronized at the receiver.

It is desirable to have the benefits of a leaky bucket when the uplink speeds are varying widely, or when the codec output is closely matched to the uplink speed, and be able to tune the characteristics of the bucket (when to overflow) according to several inputs. In addition, managing these in such a way as to minimize impact on latency and synchronization is highly desirable.

The Rate Control System or module of this invention includes two inputs, one of which take video frames, and one of which takes chunks of audio samples. The input to each of these is packetized according to commonly accepted and well known standards such as, but not limited to, the RFC 3016, 2429 standards for video and the ISMA standard for audio. Once the inputs are packetized, the resultant datagrams are funneled into two, independent ring buffers, one for video, the other for audio.

When these ring buffers overflow, they block the execution of the code which pushes contents onto them.

Another thread of execution continually checks the audio and video ring buffers and maintains a history of what datagrams it has sent over the network, when, and how large they were. An independent history is tabulated for both audio and video datagrams. When the history indicates that the next audio datagram in the ring buffer would not bring the system over-budget, the audio datagram is popped from the ringbuffer and sent on the network. The history is them updated. The same process is repeated for video.

The sizes of these ring buffers have a profound effect on the behavior of the system: the larger the ring buffers, the larger the allowed latency for the system, and the more reactive and stringent the rate control. If the ring buffers are reduced in size, the rate control becomes “looser” and the latency approaches zero as the allowed ring buffer overflow size approaches zero.

### CONCLUSION

Having now described preferred embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

For example, the present invention may be implemented in hardware or software, or a combination of the two. Preferably, aspects of the present invention are implemented in one or more computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner. For illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device. It will be appreciated that the system, method of operation and product may vary as to the details of its configuration and operation without departing from the basic concepts disclosed herein.

What is claimed is:

1. A method of initializing a video system, said video system including at least a first and a second endpoint connected via a communications network; said method including:
determining first endpoint parameters of said first endpoint;
sending said first endpoint parameters along with an invite request message to said second endpoint;
receiving said invite request message and first endpoint parameters at said second endpoint;
determining second endpoint parameters of said second endpoint;
sending an acknowledgement message along with said second parameters to said first endpoint; and
initializing said first and second endpoints using the parameters of the other endpoint to select appropriate parameter values by referring to predefined common look-up tables and predefined rules at said first and second endpoints.

2. A method as in claim 1 wherein said communications network is a local area network, wide area network (WAN), satellite network, wireless communications network, value added network (VAN), telephone network (POTS), private leased line network or any combination of the foregoing

3. A method as in claim 2 wherein said communications network is the Internet.

4. A method as in claim 1 wherein each of said endpoints is a video enabled system.

5. A method as in claim 4 wherein each of said endpoints is a computer system.

6. A method as in claim 1 wherein said first and second endpoint parameters include performance characteristics parameters.

7. A method as in claim 6 wherein said performance characteristics parameters include first and second endpoint CPU speeds, first and second endpoint ordinal profiles, a set of predefined encoding formats appropriate for second endpoint decoding; a current frame size, a current frame rate, and a current encoder format.

8. A method as in claim 7 wherein said initialization step further comprises:
if said second endpoint cannot decode said current encoder format then assigning said current encoder format to an encoding format appropriate for second endpoint decoding based on said predefined rules;
otherwise, obtaining, using said current frame size, first, second and third cost factors of said first or second endpoints from said predefined common tables; wherein said first cost factor is the number of CPU clock cycles to encode a frame on said first endpoint; said second cost factor is the number of CPU clock cycles to decode a frame on said second endpoint; and said third cost factor is the number of CPU clock cycles to render a frame on said second endpoint;
if, based on said first cost factor, said first endpoint encoding does not consume more than about 60% of available CPU resources then
if, based on said second and third cost factors, said second endpoint decoding and rendering does not consume more than about 40% of available CPU resources then terminating said initialization step; otherwise
if said current frame size is has not been once reduced then reduce said current frame size by half;
otherwise if said current frame size is twice reduced then setting said current encoder format to an appropriate value based on said predefined rules;
otherwise reducing said current frame rate by about 75%.

9. A video initialization system, comprising:
a communications network;
at least a first and a second endpoint connected via said communications network;
said first endpoint configured to:
determine first endpoint parameters of said first endpoint;
send said first endpoint parameters along with an invite request message to said second endpoint;
said second endpoint configured to:
receive said invite request message and first endpoint parameters at said second endpoint;
determine second endpoint parameters of said second endpoint;
send an acknowledgement message along with said second parameters to said first endpoint; and
each of said first and second endpoints configured to:
initialize said respective first and second endpoints using the parameters of the other endpoint to select appropriate parameter values by referring to predefined common look-up tables and predefined rules at said respective first and second endpoint

10. A system as in claim 9 wherein said communications network is a local area network, wide area network (WAN), satellite network, wireless communications network, value added network (VAN), telephone network (POTS), private leased line network or any combination of the foregoing.

11. A system as in claim 9 wherein said communications network is the Internet.

12. A system as in claim 9 wherein each of said endpoints is a video enabled system;

13. A system as in claim 12 wherein each of said endpoints is a computer system.

14. A system as in claim 9 wherein said first and second endpoint parameters include performance characteristics parameters.

15. A system as in claim 14 wherein said performance characteristics parameters include first and second endpoint CPU speeds, first and second endpoint ordinal profiles, a set of predefined encoding formats appropriate for second endpoint decoding; a current frame size, a current frame rate, and a current encoder format.

16. A system as in claim 15 wherein during initialization said system is further configured to:
if said second endpoint cannot decode said current encoder format then assigning said current encoder format to an encoding format appropriate for second endpoint decoding based on said predefined rules;
otherwise, obtaining, using said current frame size, first, second and third cost factors of said first or second endpoints from said predefined common tables; wherein said first cost factor is the number of CPU clock cycles to encode a frame on said first endpoint; said second cost factor is the number of CPU clock cycles to decode a frame on said second endpoint; and said third cost factor is the number of CPU clock cycles to render a frame on said second endpoint;
if, based on said first cost factor, said first endpoint encoding does not consume more than about 60% of available CPU resources then
if, based on said second and third cost factors, said second endpoint decoding and rendering does not consume more than about 40% of available CPU resources then terminating said initialization step; otherwise
if said current frame size is has not been once reduced then reduce said current frame size by half;
otherwise if said current frame size is twice reduced then setting said current encoder format to an appropriate value based on said predefined rules;
otherwise reducing said current frame rate by about 75%.
